(19) United States
(12) Patent Application Publication
(10) Pub. No.: US 2026/0344593 A1
(43) Pub. Date: Nov. 5, 2026

(54) LIQUID TREATMENT APPARATUS FOR NUTRIENT SOLUTION CULTIVATION AND NUTRIENT SOLUTION CULTIVATION SYSTEM USING SAME

(71) Applicant: PURE PLATECH CO., LTD., Hwaseong-si, Gyeonggi-do (KR)

(72) Inventors: Kyoung Doo KANG, Yongin-si, Gyeonggi-do (KR); Min Jae KIM, Hwaseong-si, Gyeonggi-do (KR); Dae Ryong JI, Hwaseong-si, Gyeonggi-do (KR); Seong Hwan MOON, Hwaseong-si, Gyeonggi-do (KR); Kyoung Jun KO, Hwaseong-si, Gyeonggi-do (KR)

(73) Assignee: PURE PLATECH CO., LTD., Hwaseong-si, Gyeonggi-do (KR)

(21) Appl. No.: 19/116,428

(22) PCT Filed: Sep. 21, 2023
(86) PCT No.: PCT/KR2023/014351

§ 371 Date: Mar. 28, 2025

(30) Foreign Application Priority Data
Sep. 29, 2022 (KR) 10-2022-0124085
Sep. 4, 2023 (KR) 10-2023-0116989

(51) Int. Cl. A01G 31/00; C02F 1/32; C02F 1/46; C02F 1/461

(52) U.S. Cl. CPC A01G 31/008; C02F 1/325; C02F 1/4608; C02F 1/46109; C02F 2001/46161; C02F 2001/46171; C02F 2303/04

(57) ABSTRACT

According to the present invention, provided is a liquid treatment apparatus for nutrient solution culture, for treating liquid used for nutrient solution culture, the apparatus including: a main treatment tank in which a main treatment space for storing a liquid to be treated is provided; a spray nozzle for spraying, in a bubble form, in the main treatment space, treatment gas for treating the liquid to be treated; a plasma reactor using a plasma reactor so as to generate the treatment gas supplied through the spray nozzle; and an ultraviolet lamp for generating, in the main treatment space, ultraviolet rays for treating the liquid to be treated.

### CROSS REFERENCE TO PRIOR APPLICATIONS

This application is a National Stage Application of PCT International Patent Application No. PCT/KR2023/014351 filed Sep. 21, 2023, under 35 U.S.C. § 371, which claims priority to Korean Patent Application Nos. 10-2022-0124085 filed Sep. 29, 2022 and 10-2023-0116989 filed Sep. 4, 2023, which are all hereby incorporated by reference in their entirety.

### TECHNICAL FIELD

The present invention relates to cultivation technology using a nutrient solution, and more particularly, to liquid treatment technology used for nutrient solution cultivation.

### BACKGROUND ART

In general, nutrient solution cultivation is an agricultural method in which land plants are grown using water with a nutrient solution without soil, and the nutrient solution is supplied directly to the plant roots or soaked in an inert support that acts as a root support. Compared to absorbing nutrients through the soil, when nutrients are supplied through the nutrient solution, plants absorb nutrients much more efficiently, so that the effects of promoting growth are obtained. By using this nutrient solution cultivation method, the growth environment of plants can be controlled in detail so that it is possible to not only increase production but also control harvest time. Also, it enables crop production in areas where soil quality has deteriorated or where it is difficult to grow crops.

Korean Patent Laid-open Publication No. 10-2012-0024352, which is a prior patent document related to the present invention, discloses a configuration for reusing a nutrient solution by sterilizing microorganisms contained in waste water discharged from a cultivation medium using an ultraviolet lamp.

### DETAILED DESCRIPTION OF THE INVENTION

### Technical Problem

The present invention provides a liquid treatment apparatus for nutrient solution cultivation in which a sterilizing effect is enhanced and nutritional information is generated, and a nutrient solution cultivation system using the same.

### Technical Solution

According to an aspect of the present invention, there is provided a liquid treatment apparatus for nutrient solution cultivation as an apparatus, for treating liquid used for nutrient solution cultivation, the liquid treatment apparatus including: a main treatment tank in which a main treatment space for storing a liquid to be treated is provided; a spray nozzle for spraying, in a bubble form, in the main treatment space, treatment gas for treating the liquid to be treated; a plasma reactor using a plasma reaction so as to generate the treatment gas supplied through the spray nozzle; and an ultraviolet lamp for generating, in the main treatment space, ultraviolet rays for treating the liquid to be treated.

According to another embodiment of the present invention, there is provided a liquid treatment apparatus for nutrient solution cultivation as an apparatus, for treating liquid used for nutrient solution cultivation, the liquid treatment apparatus including: a main treatment tank in which a main treatment space for storing a liquid to be treated is provided; a spray nozzle for supplying, in a bubble form, in the main treatment space, discharge gas as the liquid to be treated; an electrode module placed above the spray nozzle in the main treatment space and for generating plasma discharge within the liquid to be treated using the discharge gas; and a power supply unit for supplying power to the electrode module, wherein the electrode module includes a first electrode structure and a second electrode structure which interact with each other and generate the plasma discharge, and the first electrode structure includes a plurality of rod-shaped first electrode members arranged to be spaced apart from each other on a horizontal plane.

According to another embodiment of the present invention, there is provided a liquid treatment apparatus for nutrient solution cultivation as an apparatus, for treating liquid used for nutrient solution cultivation, the liquid treatment apparatus including: a main treatment tank in which a main treatment space for storing a liquid to be treated is provided; a spray nozzle for supplying, in a bubble form, in the main treatment space, discharge gas as the liquid to be treated; an electrode module placed above the spray nozzle in the main treatment space and for generating plasma discharge within the liquid to be treated using the discharge gas; and a power supply unit for supplying power to the electrode module, wherein the electrode module includes a first electrode structure and a second electrode structure which interact with each other and generate the plasma discharge, and the first electrode structure includes a plate-shaped member with a plurality of through holes, and the second electrode structure has a mesh shape disposed above or below the first electrode structure.

According to another embodiment of the present invention, there is provided a nutrient solution cultivation system including: a plant cultivation bed in which a plant to be cultivated by a nutrient solution is planted; a nutrient solution tank in which the nutrient solution supplied to the plant cultivation bed is stored; and a liquid treatment apparatus for treating a nutrient solution after use discharged from the plant cultivation bed, wherein the liquid treatment apparatus includes a main treatment tank in which a main treatment space for storing the nutrient solution after use is provided, a spray nozzle for spraying, in a bubble form, in the main treatment space, treatment gas for treating the nutrient solution after use, an ultraviolet lamp for generating ultraviolet rays for treating the nutrient solution after use in the main treatment space, and a plasma reactor using a plasma reaction so as to generate the treatment gas supplied through the spray nozzle, and a treatment liquid in which the nutrient solution after use is treated by the liquid treatment apparatus and is discharged, is supplied to the nutrient solution tank.

According to another embodiment of the present invention, there is provided a nutrient solution cultivation system including: a plant cultivation bed in which a plant to be cultivated by a nutrient solution is planted; a nutrient solution tank in which the nutrient solution supplied to the plant cultivation bed is stored; and a liquid treatment apparatus for treating raw water supplied to the nutrient solution tank, wherein the liquid treatment apparatus includes a main treatment tank in which a main treatment space for storing the raw water is provided, a spray nozzle for spraying, in a bubble form, in the main treatment space, treatment gas for treating the raw water, an ultraviolet lamp for generating ultraviolet rays for treating the raw water in the main treatment space, and a plasma reactor using a plasma reaction so as to generate the treatment gas supplied through the spray nozzle.

According to another embodiment of the present invention, there is provided a nutrient solution cultivation system including: a plant cultivation bed in which a plant to be cultivated by a nutrient solution is planted; a nutrient solution tank in which the nutrient solution supplied to the plant cultivation bed is stored; and a liquid treatment apparatus for treating a nutrient solution after use discharged from the plant cultivation bed, wherein the liquid treatment apparatus includes a main treatment tank in which a main treatment space for storing the nutrient solution after use is provided, a spray nozzle for spraying, in a bubble form, in the main treatment space, discharge gas as the nutrient solution after use, an electrode module placed above the spray nozzle in the main treatment space and for generating plasma discharge within the nutrient solution after using the discharge gas, and an ultraviolet lamp for generating ultraviolet rays for treating the nutrient solution after use in the main treatment space, and a treatment liquid in which the nutrient solution after use is treated by the liquid treatment apparatus and is discharged, is supplied to the nutrient solution tank.

According to another embodiment of the present invention, there is provided a nutrient solution cultivation system including: a plant cultivation bed in which a plant to be cultivated by a nutrient solution is planted; a nutrient solution tank in which the nutrient solution supplied to the plant cultivation bed is stored; and a liquid treatment apparatus for treating raw water supplied to the nutrient solution tank, wherein the liquid treatment apparatus includes a main treatment tank in which a main treatment space for storing the raw water, a spray nozzle for supplying, in a bubble form, in the main treatment space, discharge gas as the raw water, an electrode module placed above the spray nozzle in the main treatment space and for generating plasma discharge within the raw water using the discharge gas, and an ultraviolet lamp for generating ultraviolet rays for treating the raw water in the main treatment space.

### Effects of the Invention

According to the present invention, all of the objectives of the present invention described above can be achieved. Specifically, treatment gas generated by plasma treatment of air in a nutrient solution after use or raw water to be treated is supplied so that the effects of sterilization and nutrient supply can be achieved simultaneously, and additionally, ultraviolet rays are generated in the nutrient solution after use or raw water to be treated, so that the effects of sterilization can be further enhanced.

### DESCRIPTION OF THE DRAWINGS

FIG. 1 is a view schematically illustrating a configuration of a nutrient solution cultivation system according to an embodiment of the present invention.

FIG. 2 is a view schematically illustrating a configuration of a liquid treatment apparatus in the nutrient solution cultivation system shown in FIG. 1.

FIG. 3 is a longitudinal cross-sectional view of a main treatment tank in which the inside of the main treatment tank is visible in the liquid treatment apparatus shown in FIG. 2.

FIG. 4 is a cross-sectional view of the main treatment tank in which the inside of the main treatment tank is visible in the liquid treatment apparatus shown in FIG. 2.

FIG. 5 is a longitudinal cross-sectional view of an additional treatment tank in which the inside of the additional treatment tank is visible in the liquid treatment apparatus shown in FIG. 2.

FIG. 6 is a perspective view illustrating an additional treatment liquid supply pipe in the configuration of FIG. 5.

FIG. 7 is a graph illustrating an embodiment of a driving method of the liquid treatment apparatus shown in FIG. 2.

FIG. 8 is a graph illustrating another embodiment of a driving method of the liquid treatment apparatus shown in FIG. 2.

FIG. 9 is a graph illustrating another embodiment of a driving method of the liquid treatment apparatus shown in FIG. 2.

FIG. 10 is a view schematically illustrating a configuration of a nutrient solution cultivation system according to another embodiment of the present invention.

FIG. 11 is a view schematically illustrating a configuration of a nutrient solution cultivation system according to another embodiment of the present invention.

FIG. 12 is a view schematically illustrating a configuration of a liquid treatment apparatus in the nutrient solution cultivation system shown in FIG. 11.

FIG. 13 is a longitudinal cross-sectional view of a main treatment tank in which the inside of the main treatment tank is visible in the liquid treatment apparatus shown in FIG. 12.

FIGS. 14 and 15 are perspective views illustrating an electrode module provided in the main treatment tank shown in FIG. 13, which respectively illustrate that an upper part and a lower part of the electrode module are visible.

FIG. 16 is a cross-sectional view of the electrode module shown in FIGS. 14 and 15.

FIGS. 17, 18, and 19 illustrate other embodiments of an electrode member provided in the electrode module shown in FIGS. 14 and 15.

FIG. 20 illustrates another embodiment of the electrode module shown in FIGS. 14 and 15.

FIG. 21 illustrates another embodiment of the electrode module shown in FIGS. 14 and 15.

FIG. 22 illustrates another embodiment of the electrode module shown in FIGS. 14 and 15.

### MODE OF THE INVENTION

Hereinafter, the configuration and operation of the present invention will be described in detail by describing embodiments of the present invention with reference to the accompanying drawings.

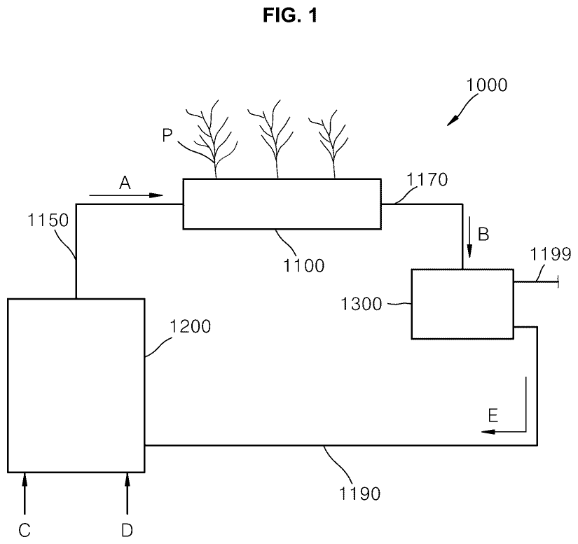

FIG. 1 illustrates a schematic configuration of a nutrient solution cultivation system according to an embodiment of the present invention. Referring to FIG. 1, a nutrient solution cultivation system 1000 according to an embodiment of the present invention includes a plant cultivation bed 1100 in which plants P to be cultivated are placed and cultivated, a nutrient solution tank 1200 in which a nutrient solution A supplied to the plant cultivation bed 1100 is stored, and a liquid treatment apparatus 1300 for treating a nutrient solution B after use discharged from the cultivation bed 1100. In the present embodiment, the nutrient solution A means a mixture of fertilizer ingredients required for plant cultivation in water such as underground water, rainwater, tap water or the like.

The plant cultivation bed 1100 that is a configuration generally used in medium cultivation using the nutrient solution includes a water tank in which the nutrient solution A is accommodated, and a medium unit which absorbs the nutrient solution A in the water tank and supports plants P to be cultivated. The plant cultivation bed 1100 receives the nutrient solution A through a nutrient solution supply pipe 1150. The nutrient solution B after use discharged from the plant cultivation bed 1100 is discharged through a nutrient solution discharge pipe 1170.

The nutrient solution A is stored in the nutrient solution tank 1200, and the nutrient solution A stored in the nutrient solution tank 1200 is supplied to the plant cultivation bed 1100 through the nutrient solution supply pipe 1150. The nutrient solution A stored in the nutrient solution tank 1200 is made by mixing raw water C, a raw solution D for the nutrient solution and a treatment liquid E discharged from the liquid treatment apparatus 1300.

The liquid treatment apparatus 1300 treats the nutrient solution B after use discharged from the plant cultivation bed 1100. The liquid treatment apparatus 1300 receives the nutrient solution B after use to be treated through the nutrient solution discharge pipe 1170. The nutrient solution B after use is discharged as the treatment liquid E after being treated by the liquid treatment apparatus 1300, and the treatment liquid E is supplied to the nutrient solution tank 1200 through a reuse nutrient solution supply pipe 1190 and is reused.

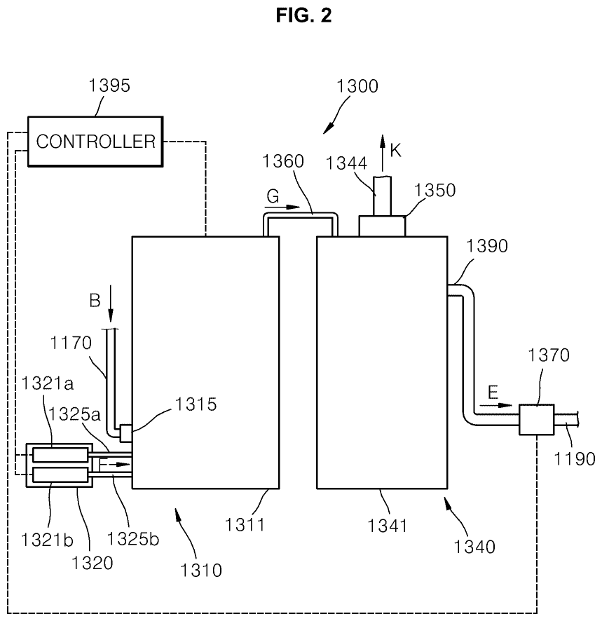

The configuration of the liquid treatment apparatus 1300 is shown in FIG. 2. Referring to FIG. 2, the liquid treatment apparatus 1300 includes a main treatment unit 1310 that treats the nutrient solution B after use discharged from a plant cultivation bed (1100 of FIG. 1) together using plasma and ultraviolet rays, an additional treatment unit 1340 that additionally treats a main treatment liquid G discharged from the main treatment unit 1310, a connection pipe 1360 that allows the main treatment unit 1310 and the additional treatment unit 1340 to communicate with each other, a treatment liquid discharge pump 1370 that discharges the treatment liquid E from the additional treatment unit 1340, a treatment liquid discharge pipe 1390 in which the treatment liquid E discharged from the additional treatment unit 1340 flows, and a controller 1395.

The main treatment unit 1310 treats the nutrient solution B after use discharged from the plant cultivation bed (1100 of FIG. 1) together using treatment gas and UV. Referring to FIGS. 2, 3, and 4, the main treatment unit 1310 includes a main treatment tank 1311 in which the nutrient solution B after use to be treated is stored, a pre-treatment filter 1315 that pre-treats the nutrient solution B after use before the nutrient solution B after use flows into the main treatment tank 1311, a treatment gas supply unit 1316 that supplies the treatment gas to the nutrient solution B after use in the main treatment tank 1311, a treatment gas generation unit 1320 that generates treatment gas F and supplies the treatment gas F to the treatment gas supply unit 1316, and an ultraviolet (UV) lamp 1330 that generates ultraviolet rays for treating the nutrient solution B after use in the main treatment tank 1311.

The main treatment tank 1311 provides a main treatment space 1312 sealed therein. The main treatment space 1312 is fully filled with the nutrient solution B after use to be treated. The treatment gas supply unit 1316 and the UV lamp 1330 are placed in the main treatment space 1312. The nutrient solution B after use filled in the main treatment space 1312 is treated by treatment gas bubbles H supplied from the treatment gas supply unit 1316 and UV of the UV lamp 1330. In the present embodiment, it will be described that the nutrient solution B after use is treated in the main treatment tank 1311 using the treatment gas bubbles H and the UV, however, the UV lamp 1330 may not be provided, and the nutrient solution B after use may also be treated only using the treatment gas bubbles H, which also belongs to the scope of the present invention.

A main treatment tank inlet 1313 is formed in the main treatment tank 1311. The nutrient solution discharge pipe 1170 is connected to the main treatment tank inlet 1313, so that the nutrient solution B after use discharged from the plant cultivation bed (1100 of FIG. 1) flows into the main treatment space 1312 through the main treatment tank inlet 1313. It is preferable that the main treatment tank inlet 1313 is placed close to the bottom of the main treatment space 1312.

A main treatment tank outlet 1314 is formed in the main treatment tank 1311. The connection pipe 1360 is connected to the main treatment tank outlet 1314, so that the nutrient solution B after use is treated in the main treatment space 1312 and then, is discharged as a main treatment liquid G from the main treatment tank 1311 through the main treatment tank outlet 1314. The main treatment tank outlet 1314 may be placed on the ceiling of the main treatment space 1312, as shown.

The pre-treatment filter 1315 pre-treats the nutrient solution B after use before the nutrient solution B after use discharged from the plant cultivation bed (1100 of FIG. 1) flows into the main treatment space 1312 of the main treatment tank 1311. The pre-treatment filter 1315 is installed on the nutrient solution discharge pipe 1170 and filters foreign substances from the nutrient solution B after use flowing into the main treatment space 1312.

The treatment gas supply unit 1316 supplies treatment gas F generated in the treatment gas generation unit 1320 from the main treatment tank 1311 to the nutrient solution B after use. The treatment gas supply unit 1316 includes a first treatment gas spray nozzle 1316a and a second treatment gas spray nozzle 1316b, which spray the treatment gas F. The first treatment gas spray nozzle 1316a and the second treatment gas spray nozzle 1316b are placed adjacent to the bottom of the main treatment space 1312. The treatment gas F sprayed by the first treatment gas spray nozzle 1316a and the second treatment gas spray nozzle 1316b to the nutrient solution B after use filled in the main treatment space 1312 may include ozone (O₃), a nitrate ion (NO₃), an oxygen ion (O), an excited oxygen atom (O*), a hydroxide ion (OH), and nitrogen monoxide (NO). Ozone (O₃), an oxygen ion (O), an excited oxygen atom (O*), a hydroxide ion (OH), and nitrogen monoxide (NO) among ingredients contained in the treatment gas F have a sterilizing effect, and a nitrate ion (NO₃) that is a nitrogen fertilizer acts as a nutrient. That is, the nutrient solution B after use is sterilized by the treatment gas F supplied to the nutrient solution B after use in the main treatment space 1312, and the nutrient is added to the nutrient solution B after use. The treatment gas F is sprayed by the first treatment gas spray nozzle 1316a and the second treatment gas spray nozzle 1316b to the nutrient solution B after use and forms bubbles H. The bubbles H are dissolved in the nutrient solution B while rising in the nutrient solution B after use. It is preferable that the first nozzle 1315a and the second nozzle 1316b supply the treatment gas F as fine bubbles of micro or nano bubbles so that the treatment gas F may be well dissolved in the nutrient solution B after use. In the present embodiment, it will be described that the treatment gas supply unit 1316 includes two treatment gas spray nozzles 1316a and 1316b, but the present invention is not limited thereto. The treatment gas supply unit 1316 may include one treatment gas spray nozzle or three or more treatment gas spray nozzles, which also belongs to the scope of the present invention.

The treatment gas generation unit 1320 generates the treatment gas F and supplies the treatment gas F to the first treatment gas spray nozzle 1316a and the second treatment gas spray nozzle 1316b of the treatment gas supply unit 1316. The treatment gas generating unit 1320 includes a first plasma reactor 1321a and a second plasma reactor 1321b, which generate the treatment gas F using a plasma reaction. Each of the first plasma reactor 1321a and the second plasma rector 1321b generates the treatment gas F using a plasma reaction. The treatment gas F generated in the first plasma reactor 1321a is supplied to the first treatment gas spray nozzle 1316a through the first treatment gas supply pipe 1325a, and the treatment gas F generated in the second plasma reactor 1321b is supplied to the second treatment gas spray nozzle 1316b through the second treatment gas supply pipe 1325b. The first plasma reactor 1321a and the second plasma reactor 1321b may use air as a source gas. The treatment gas F generated by the plasma reaction of the first plasma reactor 1321a and the second plasma reactor 1321b includes ozone (O₃), a nitrate ion (NO₃), an oxygen ion (O), an excited oxygen atom (O*), a hydroxide ion (OH), and nitrogen monoxide (NO). The operation of the first plasma reactor 1321a and the second plasma reactor 1321b is independently controlled by the controller 1395. In the present embodiment, it will be described that the treatment gas generation unit 1320 includes two plasma reactors 1321a and 1321b, but the present invention is not limited thereto. The treatment gas generation unit 1320 may include one plasma reactor or three or more plasma reactors to correspond to the number of treatment gas spray nozzles, which also belongs to the scope of the present invention.

The UV lamp 1330 is installed to be placed in the main treatment space 1312 and generates ultraviolet rays in a state in which the nutrient solution B after use is stored in the main treatment space 1312. The nutrient solution B after use stored in the main treatment space 1312 is sterilized by the ultraviolet rays generated in the UV lamp 1330. In the present embodiment, it will be described that the UV lamp 1330 extends long in a height direction and is placed generally in the center in the main treatment space 1312. The UV lamp 1330 is placed above two treatment gas spray nozzles 1316a and 1316b and is arranged between two treatment gas spray nozzles 1316a and 1316b on a plane. The bubbles H collide with the surface of the UV lamp 1330 so that scales formed on the surface of the UV lamp 1330 may be removed. The operation of the UV lamp 1330 is controlled by the controller 1395.

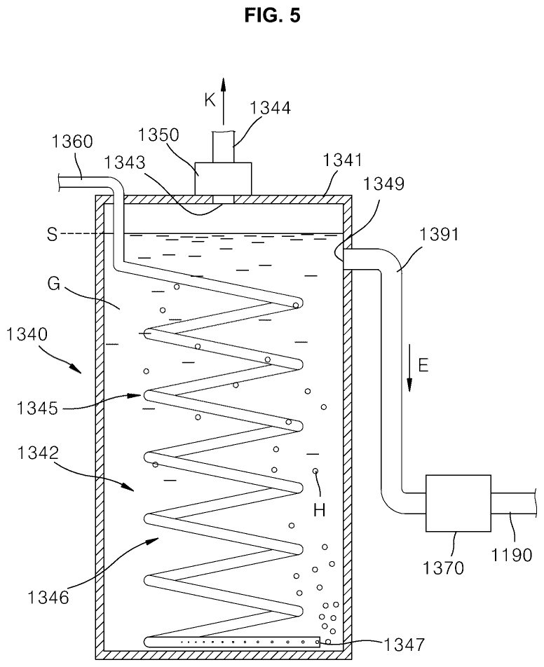

The additional treatment unit 1340 performs additional treatment on the main treatment liquid G discharged from the main treatment unit 1310. Referring to FIGS. 2 and 5, the additional treatment unit 1340 includes an additional treatment tank 1341 in which the main treatment liquid G to be treated is stored, an additional treatment liquid supply pipe 1345 that supplies the main treatment liquid G to be treated within the additional treatment tank 1341, and a gas treatment filter 1350 that treats gas K discharged from the additional treatment tank 1341.

The additional treatment tank 1341 provides an additional treatment space 1342 sealed therein. The main treatment liquid G to be treated discharged from the additional treatment liquid supply pipe 1345 is stored to a set water level S in the additional treatment tank 1342. An additional treatment tank discharge port 1349 in which the main treatment liquid G is treated in the additional treatment space 1342 and is discharged as the treatment liquid E to the outside, is formed on the upper side of the additional treatment space 1342. The water level S of the main treatment liquid G to be treated stored in the additional treatment space 1342 is maintained to be lower than the ceiling of the additional treatment space 1342 and higher than the additional treatment tank discharge port 1349. The main treatment liquid G to be treated stored in the additional treatment space 1342 is treated by the bubbles H discharged from the additional treatment liquid supply pipe 1345. The bubbles H are not dissolved in the main treatment tank 1311 and come over. A gas discharge port 1343 through which the gas K is discharged to the outside from the additional treatment space 1342, is formed at the ceiling of the additional treatment tank 1341. A gas discharge pipe 1344 is connected to the gas discharge port 1343.

The additional treatment liquid supply pipe 1345 discharges the main treatment liquid G to be treated into the additional treatment space 1342. An upstream end of the additional treatment liquid supply pipe 1345 is connected to the connection pipe 1360 so that the main treatment liquid G discharged from the main treatment tank 1311 and flowing through the connection pipe 1360 is discharged from the additional treatment space 1342 through the additional treatment liquid supply pipe 1345. Referring to FIGS. 5 and 6, the additional treatment liquid supply pipe 1345 includes a curved extension part 1346 that is curved in a spiral form and extends to form a long flow path. The flow path is long formed by the curved extension part 1346 so that a reaction time of ingredients contained in the main treatment liquid G flowing in the additional treatment liquid supply pipe 1345 and the bubbles H increases. In the present embodiment, it will be described that the curved extension part 1346 has a coil shape extending in a spiral form, but the present invention is not limited thereto. The curved extension part 1346 that forms a flow path long in the additional treatment liquid supply pipe 1345 may have other various shapes such as a zigzag shape or the like, which also belongs to the scope of the present invention. A downstream end of the additional treatment liquid supply pipe 1345 is open and forms an additional treatment liquid discharge opening 1347 through which the main treatment liquid G is discharged. The additional treatment liquid discharge opening 1347 is placed lower than the additional treatment tank discharge port 1349. The main treatment liquid G is discharged together with the bubbles H into the additional treatment space 1342 through the additional treatment liquid discharge opening 1347. In the present embodiment, it will be described that the curved extension part 1346 is disposed to extend downward as it goes downstream. An upstream end of the additional treatment liquid supply pipe 1345 is connected to a downstream end of the connection pipe 1360 at the ceiling of the additional treatment space 1342. In the present embodiment, it will be described that the additional treatment liquid supply pipe 1345 is formed of a flexible material so that formation of the curved extension part 1346 is facilitated.

A plurality of bubble discharge holes 1348 are formed in the additional treatment liquid supply pipe 1345 over a certain section A. In the present embodiment, it will be described that a section in which the bubble discharge holes 1348 are formed, is adjacent to the additional treatment liquid discharge opening 1347 and is disposed generally horizontally close to the bottom of the additional treatment space 1342. The bubbles H flowing with the main treatment liquid G along the additional treatment liquid supply pipe 1345 are discharged to the outside of the additional treatment liquid supply pipe 1345 through the plurality of bubble discharge holes 1348. The bubble discharge holes 1348 are used to prevent the bubbles H from clumping together and growing larger while flowing along the additional treatment liquid supply pipe 1345. The size of the bubble discharge holes 1348 formed in the additional treatment liquid supply pipe 1345 may be formed variously. In the present embodiment, it will be described that the larger the size of the bubble discharge hole 1348, the bubble discharge hole 1348 is placed closer to the additional treatment liquid discharge opening 1347. Thus, the treatment gas bubbles H having a small size may be first discharged to the outside.

Referring to FIGS. 2 and 5, the gas treatment filter 1350 is installed on the gas discharge pipe 1344. The gas treatment filter 1350 treats harmful gas ingredients such as ozone (O₃) or chlorine dioxide (ClO₂) that is not dissolved from the additional treatment space 1342 and contained in gas discharged to the outside through the gas discharge pipe 1344. Since a general configuration for treating harmful gas ingredients may be used as the gas treatment filter 1350, detailed descriptions thereof will be omitted.

Referring to FIGS. 2, 3, and 5, the connection pipe 1360 allows the main treatment tank 1311 and the additional treatment tank 1341 to communicate with each other. Both ends of the connection pipe 1360 are coupled to the main treatment tank discharge port 1314 formed in the main treatment tank 1311 and the additional treatment liquid supply pipe 1345 installed in the additional treatment tank 1341, respectively. Although not shown, the connection pipe 1360 may extend in a zigzag form to form a long flow path. In this case, time at which the ingredients contained in the bubbles H may be dissolved while the main treatment liquid G flows along the connection pipe 1360, may be increased. The water level S of the additional treatment space 1342 is formed lower than the water level of the main treatment space 1312 so that the liquid stored in the main treatment space 1312 may flow into the additional treatment space 1342 through the connection pipe 1360 without external power.

The treatment liquid discharge pump 1370 discharges the treatment liquid E from the additional treatment unit 1340. The nutrient solution discharge pump 1370 is installed between the treatment liquid discharge pipe 1390 and the reuse nutrient solution supply pipe 1190 and supplies the treatment liquid E discharged from the additional treatment unit 1340 to the nutrient solution tank (1200 of FIG. 1). A liquid discharged through the treatment liquid discharge pump 1370 may not be supplied to the nutrient solution tank 1200 but may be discharged through a discard line (not shown) and discarded. The operation of the treatment liquid discharge pump 1370 is controlled by the controller 1395.

The treatment liquid E discharged from the additional treatment space 1341 flows through the treatment liquid discharge pipe 1390. The treatment liquid discharge pipe 1390 extends from the additional treatment tank discharge port 1349 formed in the additional treatment tank 1341 and is connected to the treatment liquid discharge pump 1370.

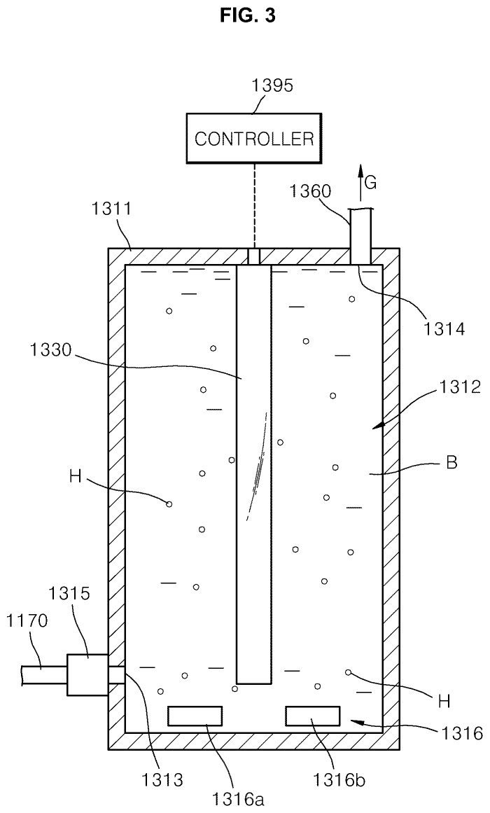

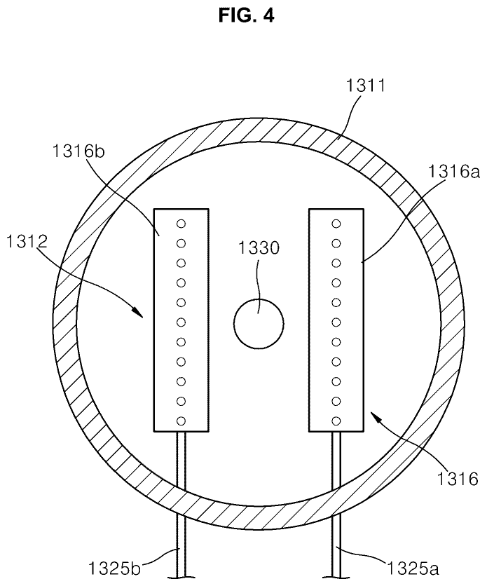

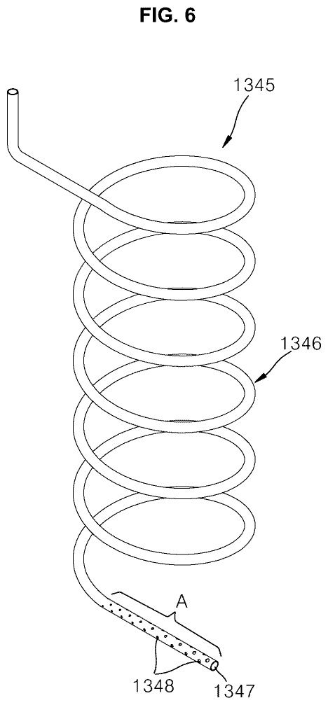

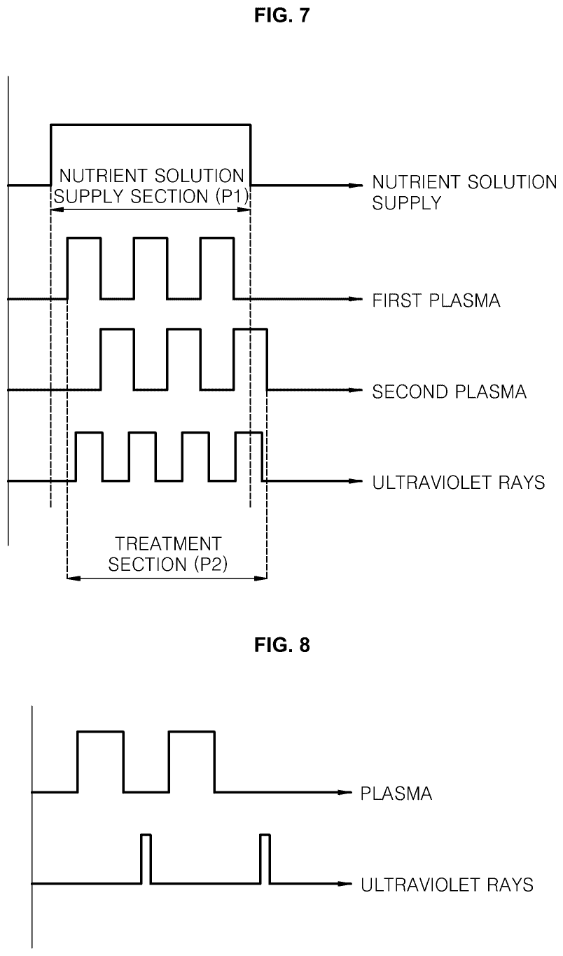

The controller 1395 controls the operation of the first and second plasma reactors 1321a and 1321b, the UV lamp 1330, and the treatment liquid discharge pump 1370. A graph for describing an action of the controller 1395 is shown in FIG. 7. Referring to FIG. 7, nutrient solution supply refers to supplying the nutrient solution B after use to be treated to the main treatment tank (1311 of FIGS. 2 and 3) and is controlled by the operation of the treatment liquid discharge pump (1370 of FIG. 2) controlled by the controller (1395 of FIG. 2). A treatment section P2 is prepared to correspond to a nutrient solution supply section P1 that is a temporal section in which the nutrient solution is supplied. The treatment section P2 is a temporal section in which the nutrient solution B after use is treated in the main treatment tank (1311 of FIGS. 2 and 3). The treatment section P2 partially overlaps the nutrient solution supply section P1 and is formed by being delayed than the nutrient solution supply section. In a treatment section, the first plasma reactor (1321a of FIG. 2), the second plasma reactor (1321b of FIG. 2), and the UV lamp (1330 of FIGS. 3 and 4) operate while being controlled by the controller (1395 of FIG. 2).

In the treatment section P2, the first plasma reactor (1321a of FIG. 2) and the second plasma reactor (1321b of FIG. 2) operate alternately, generate treatment gas, and supply the treatment gas. That is, in the treatment section P2, when the first plasma reactor (1321a of FIG. 2) operates, the second plasma reactor (1321b of FIG. 2) does not operate, and when the second plasma reactor (1321b of FIG. 2) operates, the first plasma reactor (1321a of FIG. 2) does not operate. By such an operation of the first plasma reactor (1321a of FIG. 2) and the second plasma reactor (1321b of FIG. 2), plasma reaction efficiency is enhanced.

In the treatment section P2, the UV lamp (1330 of FIGS. 3 and 4) operates intermittently, that is, by turning on and off alternately. In this way, the UV lamp 1330 operates intermittently so that temperature rise may be suppressed.

In the treatment section P2, it is preferable that energy of plasma is formed to be greater than energy of ultraviolet rays. For example, when first plasma of 100 W and second plasma of 100 W are used, a lower UV lamp of 50 W may be used.

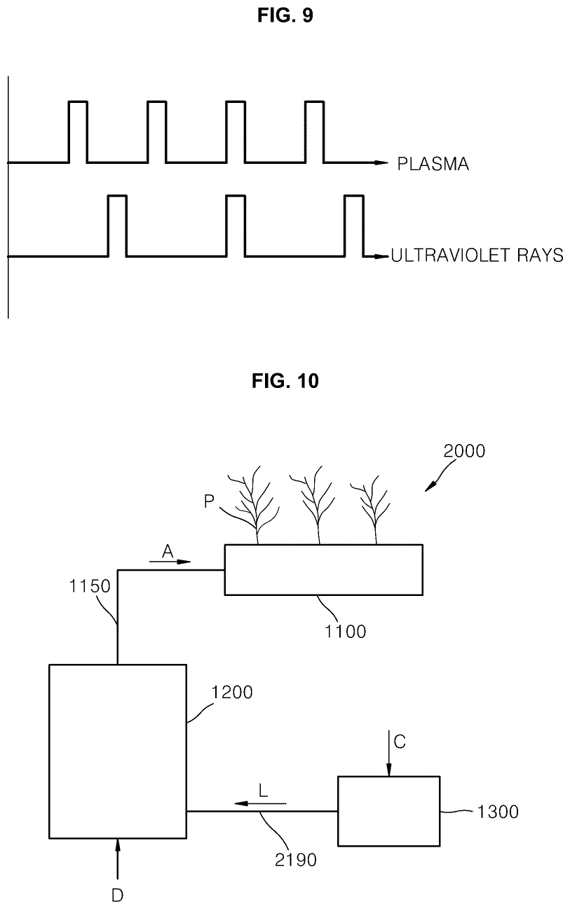

In addition, in the treatment section P2, it is preferable that the operation time of plasma is longer than the operation time of the UV lamp. An example thereof is shown in FIGS. 8 and 9. First, as shown in FIG. 8, when plasma and the UV lamp operate with the same period, the operation time of one plasma may be set to be longer than the operation time of one UV lamp. Next, as shown in FIG. 9, when the operation time of one plasma and the operation time of one UV lamp are the same, the operation period of plasma may be set to be shorter than the operation period of the UV lamp.

In the embodiment of FIG. 2, it has been described that the nutrient solution after use treated in the main treatment unit 1320 is supplied to the additional treatment unit 1340 and is additionally treated, however, unlike this, additional treatment by the additional treatment unit 1340 may be omitted, which also belongs to the scope of the present invention.

FIG. 10 shows the configuration of a nutrient solution cultivation system according to another embodiment of the present invention. Referring to FIG. 10, a nutrient solution cultivation system 2000 according to another embodiment of the present invention includes a plant cultivation bed 1100 in which a plant P to be cultivated is placed and cultivated, a nutrient solution tank 1200 in which a nutrient solution A supplied to the plant cultivation bed 1100 is stored, and a liquid treatment apparatus 1300 that treats raw water C supplied to the nutrient solution tank 1200.

The plant cultivation bed 1100 is generally the same as the plant cultivation bed 1100 of the embodiment shown in FIG. 1.

The nutrient solution tank 1200 is generally the same as the nutrient solution tank 1200 of the embodiment shown in FIG. 1. The nutrient solution A stored in the nutrient solution tank 1200 is supplied to the plant cultivation bed 1100 through the nutrient solution supply pipe 1150. The nutrient solution A stored in the nutrient solution tank 1200 is a mixture of a nutrient solution raw solution D and a treatment liquid L discharged from the liquid treatment apparatus 1300.

The liquid treatment apparatus 1300 treats a raw water C. The raw water C is discharged as the treatment liquid L after being treated in the liquid treatment apparatus 1300, and the treatment liquid L is supplied to the nutrient solution tank 1200 through a raw water supply pipe 1290 and is reused. In the present embodiment, it will be described that the raw water C is underground water, but the present invention is not limited thereto. The configuration and action of the liquid treatment apparatus 1300 are generally the same as the liquid treatment unit 1300 of the embodiment described with reference to FIGS. 1 through 7.

In addition, the liquid treatment apparatus 1300 may be used to treat the nutrient solution A discharged from the nutrient solution tank 1200 and to supply the nutrient solution A to the plant cultivation bed 1100 in FIG. 1, which also belongs to the scope of the present invention.

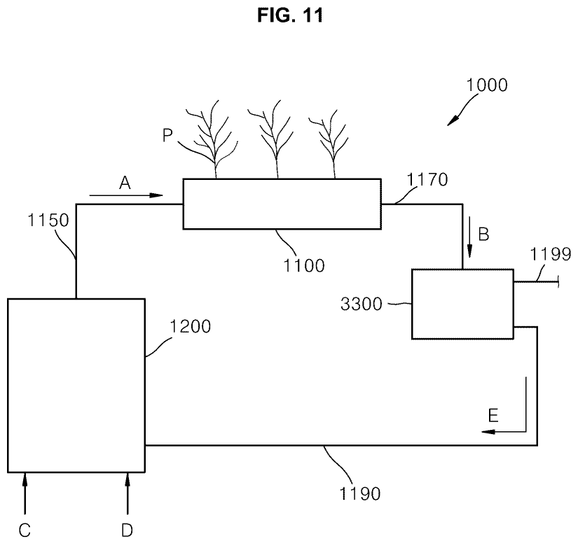

FIG. 11 shows the schematic configuration of a nutrient solution cultivation system according to another embodiment of the present invention. Referring to FIG. 11, a nutrient solution cultivation system 3000 according to another embodiment of the present invention includes a plant cultivation bed 1100 in which a plant P to be cultivated is placed and cultivated, a nutrient solution tank 1200 in which a nutrient solution B after use to be supplied to the plant cultivation bed 1100 is stored, and a liquid treatment apparatus 3300 that treats the nutrient solution B after use discharged from the cultivation bed 1100. Since the plant cultivation bed 1100 has the same configuration as the configuration of the plant cultivation bed 1100 of the embodiment shown in FIG. 1, and the nutrient solution tank 1200 has the same configuration as the configuration of the nutrient solution tank 1200 of the embodiment shown in FIG. 1, here, only the liquid treatment apparatus 3300 will be described.

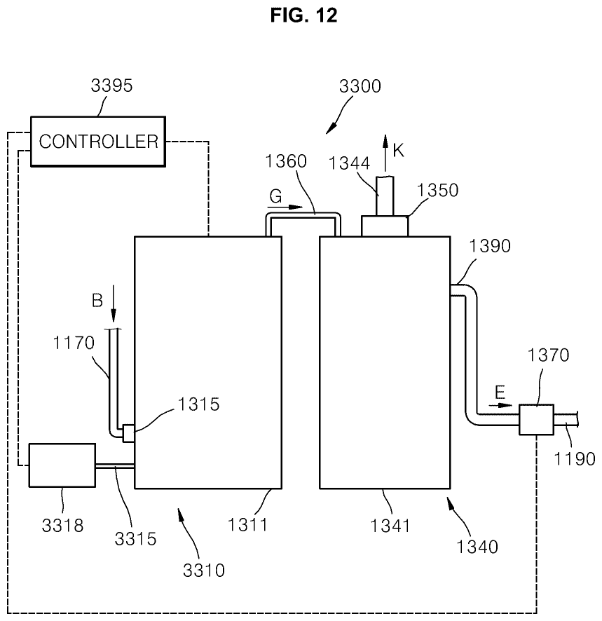

FIG. 12 shows the configuration of the liquid treatment apparatus 3300. Referring to FIG. 12, the liquid treatment apparatus 3300 includes a main treatment unit 3310 that treats the nutrient solution B after use discharged from the plant cultivation bed 1100 using plasma and ultraviolet rays together, an additional treatment unit 1340 that additionally treats a main treatment liquid G discharged from the main treatment unit 3310, a connection pipe 1360 that allows the main treatment unit 1310 and the additional treatment unit 1340 to communicate with each other, a treatment liquid discharge pump 1370 that discharges a treatment liquid E from the additional treatment unit 1340, a treatment liquid discharge pipe 1390 through which the treatment liquid E discharged from the additional treatment unit 1340 flows, and a controller 3395. Since the other configurations except for the main treatment unit 3310 and the controller 3395 in the liquid treatment apparatus 3300 shown in FIG. 12 are the same as those of the embodiment shown in FIG. 2, here, only the main treatment unit 3310 and the controller 3395 will be described.

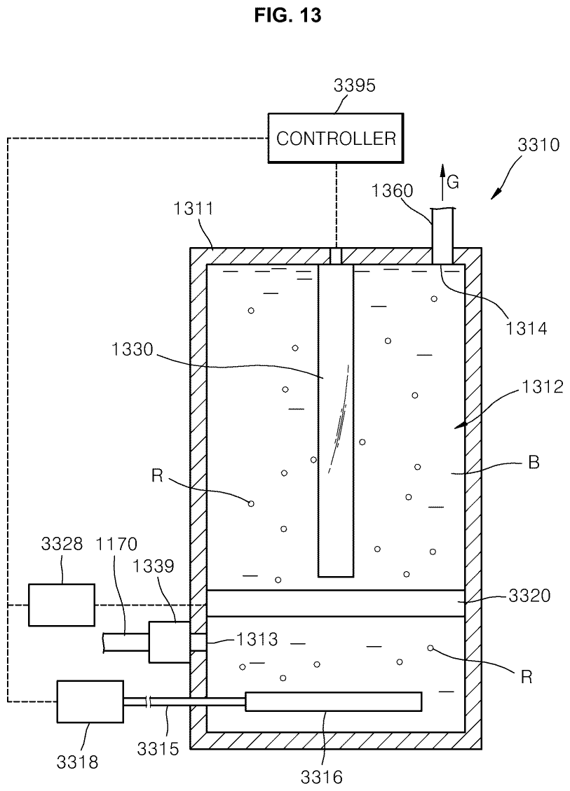

Referring to FIGS. 12 and 13, the main treatment unit 3310 includes a main treatment tank 1311 in which the nutrient solution B after use to be treated is stored, a pre-treatment filter 1315 that pre-treats the nutrient solution B after use before the nutrient solution B after use flows into the main treatment tank 1311, a discharge gas spray nozzle 3316 that supplies discharge gas to bubbles R within the main treatment tank 1311, a gas supplying unit 3318 that supplies the discharge gas for plasma discharge to the discharge gas spray nozzle 3316, an electrode module 3320 that generates plasma discharge using the bubbles R within the nutrient solution B after use stored in the main treatment tank 1311, a power supply unit 3328 that supplies power to the electrode module 3320, and an UV lamp 1330 that generates ultraviolet rays for treating the nutrient solution B after use in the main treatment tank 1311. Since the other configurations except for the discharge gas spray nozzle 3316, the gas supplying unit 3318, the electrode module 3320, and the power supply unit 3328 in the main treatment unit 3310 shown in FIGS. 12 and 13 are the same as those of the embodiment shown in FIGS. 2 and 3, here, only the discharge gas spray nozzle 3316, the gas supplying unit 3318, the electrode module 3320, and the power supply unit 3328 will be described. In the present embodiment, it will be described that the nutrient solution B after use is treated by plasma discharge and ultraviolet rays in the main treatment tank 1311, however, the nutrient solution B after use may be treated only using plasma discharge without providing the UV lamp 1330, which also belongs to the scope of the present invention.

The discharge gas spray nozzle 3316 supplies the discharge gas to the bubbles R within the main treatment tank 1311. The discharge gas spray nozzle 3316 is adjacent to the bottom in the main treatment space 1312, is placed below the electrode module 3320, and supplies the discharge gas to the bubbles R using the nutrient solution B after use fully filled in the main treatment space 1312. In the present embodiment, it will be described that the discharge gas bubbles R discharged from the discharge gas spray nozzle 3316 have the size of several mm. In order to increase treatment efficiency, micro bubbles having the size of several μm to several hundreds μm may be used as the discharge gas bubbles R, which also belongs to the scope of the present invention. The discharge gas spray nozzle 3316 is connected to the gas supplying unit 3318 through the discharge gas supply pipe 1315. Thus, the discharge gas is supplied to the discharge gas spray nozzle 3316 through the discharge gas supply pipe 1315. The discharge gas bubbles R discharged from the discharge gas spray nozzle 3316 pass through the electrode module 3320 while rising. The discharge gas bubbles R include sterilizing ingredients such as OH radical (OH) or ozone (O₃) or active ingredients such as a nitrate ion (NO₃) or an ammonium ion (NH₄⁺), which are generated by the electrode module 3320 while passing the electrode module 3320. The discharge gas bubbles R including the sterilizing ingredients and the active ingredients are dissolved in the nutrient solution B after use to be treated, and the nutrient solution B after use is sterilized and activated.

The gas supplying unit 3318 supplies the discharge gas for plasma discharge to the discharge gas spray nozzle 3316 through the discharge gas supply pipe 1315. In the present embodiment, it will be described that the gas supplying unit 3318 supplies air to the discharge gas spray nozzle 3316, however, the present invention is not limited thereto.

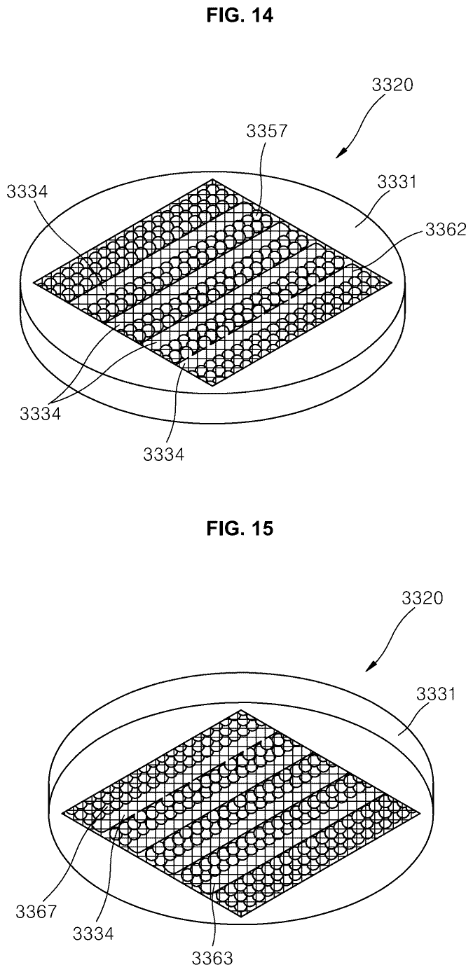

The electrode module 3320 generates plasma discharge using the discharge gas bubbles R within the nutrient solution B after use stored in the main treatment space 1312. The electrode module 3320 is placed above the discharge gas spray nozzle 3316 and below the UV lamp 1330 in the main treatment space 1312. The electrode module 3320 receives power required for an operation from the power supply unit 3328. By plasma discharge generated by the electrode module 3320, sterilizing ingredients such as OH radical (OH) or ozone (O₃) or active ingredients such as a nitrate ion (NO₃) or an ammonium ion (NH₄⁺) are generated. FIGS. 14, 15, and 16 illustrate the configuration of the electrode module 3320 in detail. Referring to FIGS. 14, 15, and 16, the electrode module 3320 includes a support structure 3331, a first electrode structure 3333 supported by the support structure 3331, a second electrode structure 3361 supported by the support structure 3331, and a plurality of dielectric members 3367 arranged between the first electrode structure 3333 and the second electrode structure 3361. In the present embodiment, the electrode module 3320 is coupled to the discharge gas spray nozzle 3316 to form one unit and may be installed to be fixed to the bottom of the main treatment space 1312, which also belongs to the scope of the present invention.

The support structure 3331 is installed to be fixed to the sidewall surface of the main treatment tank 1311 in the main treatment space 1322. The support structure 3331 is formed with a passage port 3332 that connects vertically. The first electrode structure 3333 and the second electrode structure 3361 are coupled to and supported by the support structure 3331. The plurality of dielectric members 3367 are arranged at the passage port 3332 of the support structure 3331.

The first electrode structure 3333 includes a plurality of first electrode members 3334. Each of the plurality of first electrode members 3334 has a rod shape extending generally in a straight line and is arranged at the passage port 3332 of the support structure 3331. The plurality of first electrode members 3334 are fixed so that both ends of each of the plurality of first electrode members 3334 are coupled to the support structure 3331. The first electrode member 3334 includes an electrode part 3335 in the center, and an insulating part 3336 that surrounds the electrode part 3335. The first electrode structure 3333 interacts with the second electrode structure 3361 and generates plasma discharge.

The electrode part 3335 is formed of an electrical conductive material, and receives a high voltage from the power supply unit 3328. The electrode part 3335 is not exposed to the outside by the insulating part 3336 that surrounds the outer surface of the electrode part 3335.

The insulating part 3336 surrounds the outer surface of the electrode part 3335 so that the electrode part 3335 is not exposed to the outside. The insulating part 3336 is formed of ceramic or a resin-based dielectric material.

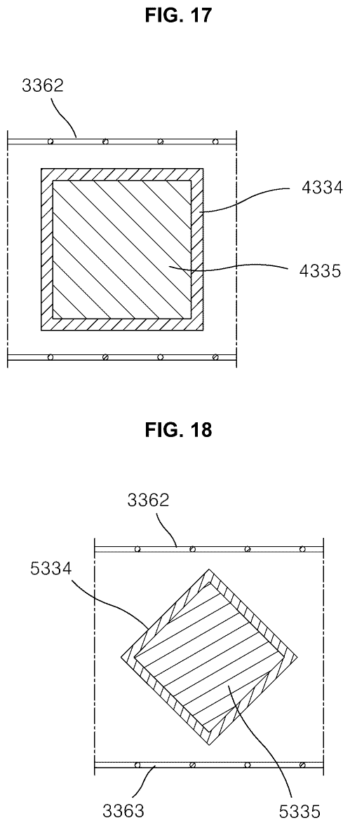

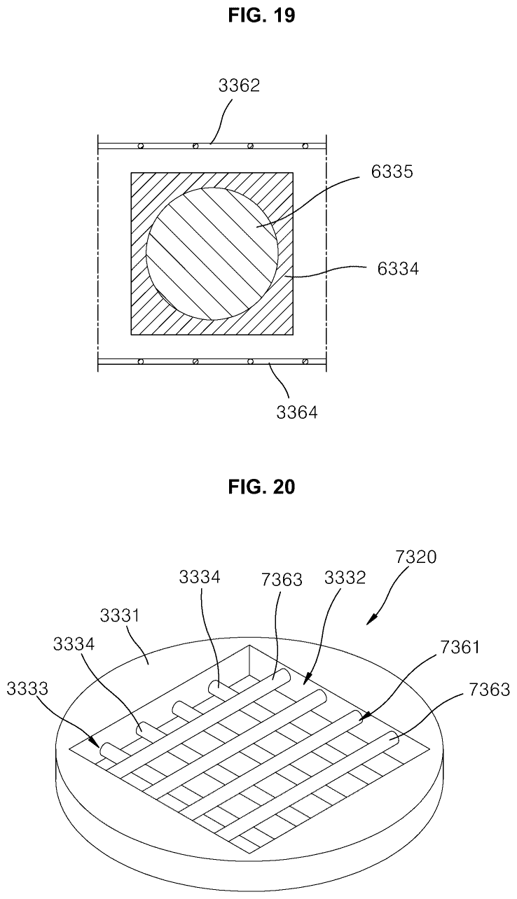

In the present embodiment, it will be described that the first electrode member 3334 has a circular rod shape with a circular cross-section, however, the present invention is not limited thereto. For example, first electrode members 4334, 5334, and 6334 shown in FIGS. 17, 18, and 19 may have rectangular rod shapes. FIGS. 17 and 18 are the case where electrode parts 4335 and 5335 have rectangular cross-section shapes, and FIG. 19 is the case where an electrode part 6335 has a circular cross-section shape. FIG. 17 is the case where the surface of the first electrode member 4334 faces upward and downward, and FIG. 18 is the case where sharp corners of the electrode member 5334 face upward and downward.

Referring to FIGS. 14, 15, and 16, the second electrode structure 3361 includes an upper mesh electrode 3362 and a lower mesh electrode 3363, which are supported by the support structure 3331. The second electrode structure 3361 interacts with the first electrode structure 3333 and generates plasma discharge.

The upper mesh electrode 3362 is formed of an electrical conductive material, and is arranged on the passage port 3332 of the support structure 3331 so as to be placed above the plurality of first electrode member 3334. The nutrient solution B after use and the bubbles H may pass through eyes formed in the upper mesh electrode 3362. In the present embodiment, it will be described that the upper mesh electrode 3362 is a ground electrode.

The lower mesh electrode 3363 is formed of an electrical conductive material, and is arranged on the passage port 3332 of the support structure 3331 so as to be placed below the plurality of first electrode member 3334. The nutrient solution B after use and the bubbles H may pass through eyes formed in the lower mesh electrode 3363. In the present embodiment, it will be described that the lower mesh electrode 3363 is a ground electrode.

In the present embodiment, it will be described that the second electrode structure 3361 uses a mesh-shaped electrode, however, any structure that has a plurality of holes through which the nutrient solution B after use and the bubbles H may pass, may be used.

In the drawings, the upper mesh electrode 3362 and the lower mesh electrode 3363 are spaced apart from the first electrode members 3334, however, for structural stability, the upper mesh electrode 3362 and the lower mesh electrode 3663 may be in close contact with the first electrode members 3334, which also belongs to the scope of the present invention.

The plurality of dielectric members 3367 are filled in a space formed between the upper mesh 3362 and the lower mesh 3363. The dielectric member 3367 is ceramic or a resin-based dielectric material, and in the present embodiment, it will be described that the dielectric member 3367 has a ball shape. The bubbles H pass through empty spaces formed between the plurality of dielectric members 3367 and the electrode module 3320 while rising within the nutrient solution B after use, and in this procedure, the bubbles H may remain in the electrode module 3320 for a long time. Thus, a plasma discharge reaction time increases so that the generating rate of sterilizing ingredients and active ingredients may be increased.

In the embodiment shown in FIGS. 14 through 16, the dielectric member 3367 may be omitted, which also belongs to the scope of the present invention.

In the embodiment shown in FIGS. 14 through 16, the upper mesh 3362 may be omitted, which also belongs to the scope of the present invention.

In the embodiment shown in FIGS. 14 through 16, one of two mesh electrodes 3362 and 3363 and the dielectric member 3367 may be omitted, which also belongs to the scope of the present invention.

The power supply unit 3328 supplies power to the electrode module 3320 so that plasma discharge is generated within the nutrient solution B after use. The operation of the power supply unit 3328 is controlled by the controller 3395.

The controller 3395 controls the operation of the power supply unit 3328 that operates the electrode module 3320, and the operation of the UV lamp 1330 and the treatment liquid discharge pump 1370.

FIG. 20 illustrates another embodiment of an electrode module. Referring to FIG. 20, an electrode module 7320 includes a support structure 3331, a first electrode structure 3333 supported by the support structure 3331, and a second electrode structure 7361 supported by the support structure 3331. The support structure 3331 has generally the same configuration as that of the support structure 3331 described above with reference to FIGS. 14 through 16, and the first electrode structure 3333 has generally the same configuration as that of the first electrode structure 3333 including the plurality of first electrode members 3334 described above with reference to FIGS. 14 through 16.

The second electrode structure 7361 is coupled to and supported by the support structure 3331 and is placed above the first electrode structure 3333. In the present embodiment, it will be described that the second electrode structure 7361 is placed above the first electrode structure 3333, however, unlike this, the second electrode structure 7361 may be placed below the first electrode structure 3333, which also belongs to the scope of the present invention. The second electrode structure 7361 includes a plurality of second electrode members 7363. Each of the plurality of second electrode members 7363 has a rod shape extending generally in a straight line and is arranged at the passage port 3332 of the support structure 3331. The plurality of second electrode members 7363 are arranged to be spaced apart from each other in parallel generally on a horizontal plane. The plurality of second electrode members 7363 are fixed so that both ends of each of the plurality of second electrode members 7363 are coupled to the support structure 3331. Each of the plurality of second electrode members 7363 is arranged to form a right angle with the first electrode member 3334 of the first electrode structure 3333 and intersects. Thus, the plurality of first electrode members 3334 and the plurality of second electrode members 7363 form a lattice form. Each of the plurality of second electrode members 7363 functions as a ground electrode.

In the embodiment of FIG. 20, it will be described that the first electrode structure 3333 and the second electrode structure 7361 include a plurality of rod-shaped electrode members 3334 and 7363, however, the present invention is not limited thereto. At least one of a first electrode structure and a second electrode structure may have a mesh shape, which also belongs to the scope of the present invention.

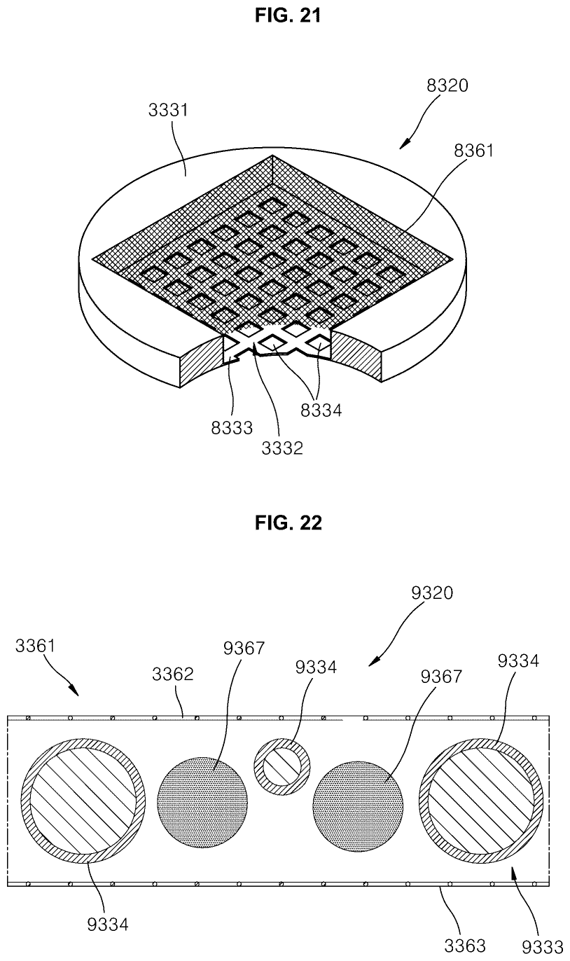

FIG. 21 illustrates another embodiment of an electrode module. Referring to FIG. 21, an electrode module 8320 includes a support structure 3331, a first electrode structure 8333 supported by the support structure 3331, and a second electrode structure 8361 supported by the support structure 3331. The support structure 3331 has generally the same configuration as that of the support structure 3331 described above with reference to FIGS. 14 through 16.

The first electrode structure 8333 that is plate-shaped member with a plurality of through holes 8334, is generally horizontally arranged. The first electrode structure 8333 is arranged at the passage port 3332 of the support structure 3331. Although not shown, the first electrode structure 8333 includes an electrode part formed of an electrical conductive material, and an insulating part coated on the electrode part so that the surface of the electrode part is not exposed to the outside. The first electrode structure 8333 functions as a driving electrode to which high-voltage electricity is applied. The first electrode structure 8333 interacts with the second electrode structure 8361 and generates plasma discharge.

The second electrode structure 8361 having a mesh shape is supported by the support structure 3331. The second electrode structure 8361 interacts with the first electrode structure 8333 and generates plasma discharge. The second electrode structure 8361 is formed of an electrical conductive material and is disposed on the passage port 3332 of the support structure 3331 so as to be placed above the first electrode structure 8361. In the present embodiment, it will be described that the second electrode structure 8361 is a ground electrode. In the present embodiment, it will be described that the second electrode structure 8361 is placed above the first electrode structure 8333, however, unlike this, the second electrode structure 8361 may be placed below the first electrode structure 8333, which also belongs to the scope of the present invention.

FIG. 22 illustrates another embodiment of an electrode module. Referring to FIG. 22, an electrode module 9320 includes a support structure (not shown), a first electrode structure 9333 supported by the support structure (not shown), a second electrode structure 3361 supported by the support structure (not shown), and a plurality of floating electrodes 9367 arranged between the first electrode structure 9333 and the second electrode structure 3361. The support structure (not shown) has generally the same configuration as that of the support structure 3331 described above with reference to FIGS. 14 through 16.

The first electrode structure 9333 is formed with different thicknesses of the first electrode member 9334 in the first electrode structure 3333 described above with reference to FIGS. 14 through 16. The first electrode member 9334 functions as a driving electrode to which high-voltage electricity is applied.

The second electrode structure 3361 has generally the same configuration as that of the second electrode structure 3361 described above with reference to FIGS. 14 through 16, and includes an upper mesh electrode 3362 and a lower mesh electrode 3363. The second electrode structure 3361 functions as a ground electrode.

The plurality of floating electrodes 9367 are placed in a space formed between the upper mesh 3362 and the lower mesh 3363 and are floatable. In the present embodiment, it will be described that the floating electrode 9367 has a ball shape and is formed of a metal material. The floating electrode 9367 acts as a ground electrode that is a second electrode underwater (when the floating electrode 9367 is in direct contact with a nutrient solution to be treated). If the floating electrode 9367 is surrounded by the bubbles H, the floating electrode 9367 acts as an electrode having an intermediate potential of the first electrode structure 9333 and the second electrode structure 3361.

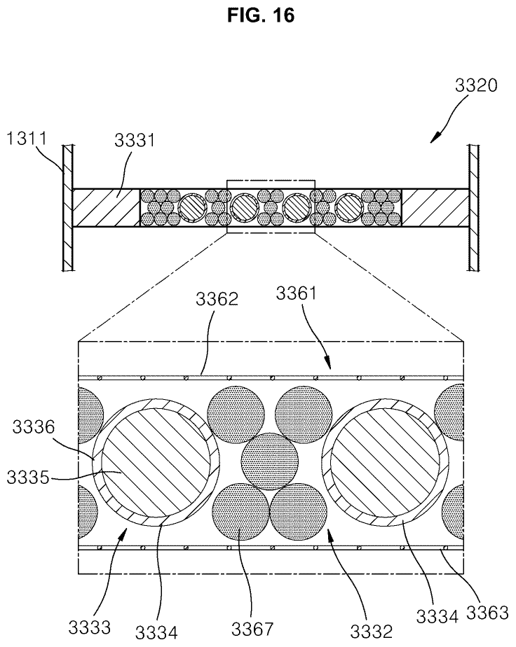

In the configuration shown in FIG. 22, although not shown, the plurality of dielectric members 3367 shown in the embodiment of FIG. 16 are additionally arranged in a space formed between the upper mesh 3362 and the lower mesh 3363 and may be filled together with the floating electrodes 9367, which also belongs to the scope of the present invention.

In FIG. 22, the present invention is applied to an embodiment in which the plurality of floating electrodes 9367 are formed with the first electrode member 9334 having different thicknesses, however, the present invention is not limited thereto. It is obvious that the present invention may be applied to an embodiment in which the floating electrode 9367 is formed with first electrode members having the same thickness, which also belons to the scope of the present invention.

Although not shown in FIG. 21, in the embodiment of FIG. 21, floating electrodes (9367 of FIG. 22) or dielectric members (3367 of FIG. 16) may be filled even in a space formed between a first electrode structure 8333 and a second electrode structure 8361, or a floating electrode and a dielectric member may be filled together, which also belongs to the scope of the present invention.

The liquid treatment apparatus shown in FIG. 12 may be applied to the configuration of the nutrient solution cultivation system shown in FIG. 10, which also belongs to the scope of the present invention.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A liquid treatment apparatus for nutrient solution cultivation as an apparatus, for treating liquid used for nutrient solution cultivation, the liquid treatment apparatus comprising:
a main treatment tank in which a main treatment space for storing a liquid to be treated is provided;
a spray nozzle for spraying, in a bubble form, in the main treatment space, treatment gas for treating the liquid to be treated;
a plasma reactor using a plasma reaction so as to generate the treatment gas supplied through the spray nozzle; and
an ultraviolet lamp for generating, in the main treatment space, ultraviolet rays for treating the liquid to be treated.

2. The liquid treatment apparatus of claim 1, wherein the spray nozzle is in plurality, and the plasma reactor is in plurality to correspond to the plurality of spray nozzles.

3. The liquid treatment apparatus of claim 2, wherein the plurality of plasma reactors operate alternately.

4. The liquid treatment apparatus of claim 1, wherein the plasma reactor and the ultraviolet lamp operate so that a treatment section that is time at which the liquid to be treated is treated, is set, and the treatment section partially overlaps a supply section of a liquid to be treated that is time at which the liquid to be treated is supplied to the main treatment space, and a starting point of the treatment section is slower than a starting point of the supply section of the liquid to be treated.

5. A liquid treatment apparatus for nutrient solution cultivation as an apparatus, for treating liquid used for nutrient solution cultivation, the liquid treatment apparatus comprising:
a main treatment tank in which a main treatment space for storing a liquid to be treated is provided;
a spray nozzle for supplying, in a bubble form, in the main treatment space, discharge gas as the liquid to be treated;
an electrode module placed above the spray nozzle in the main treatment space and for generating plasma discharge within the liquid to be treated using the discharge gas; and
a power supply unit for supplying power to the electrode module,
wherein the electrode module comprises a first electrode structure and a second electrode structure which interact with each other and generate the plasma discharge, and the first electrode structure comprises a plurality of rod-shaped first electrode members arranged to be spaced apart from each other on a horizontal plane.

6. The liquid treatment apparatus of claim 5, wherein the second electrode structure comprises a mesh electrode disposed above or below the first electrode structure.

7. The liquid treatment apparatus of claim 5, wherein the second electrode structure comprises an upper mesh electrode disposed above the first electrode structure and a lower mesh electrode disposed below the first electrode structure.

8. The liquid treatment apparatus of claim 7, wherein the electrode module further comprises a plurality of dielectric members filled in a space formed between the upper mesh electrode and the lower mesh electrode.

9. The liquid treatment apparatus of claim 7, wherein the electrode module further comprises a plurality of floating electrodes filled in a space formed between the upper mesh electrode and the lower mesh electrode.

10. The liquid treatment apparatus of claim 5, wherein the second electrode structure is disposed above or below the first electrode structure, and the second electrode structure comprises a plurality of rod-shaped second electrode members arranged to be spaced apart from each other on the horizontal plane, and the first electrode member and the second electrode member are arranged to extend in an intersecting direction.

11. The liquid treatment apparatus of claim 5, wherein the first electrode member comprises an electrode part formed of an electrical conductive material, and an insulating part formed of a dielectric material that surrounds an outer surface of the electrode part so that the electrode part is not exposed.

12. A liquid treatment apparatus for nutrient solution cultivation as an apparatus, for treating liquid used for nutrient solution cultivation, the liquid treatment apparatus comprising:
a main treatment tank in which a main treatment space for storing a liquid to be treated is provided;
a spray nozzle for supplying, in a bubble form, in the main treatment space, discharge gas as the liquid to be treated;
an electrode module placed above the spray nozzle in the main treatment space and for generating plasma discharge within the liquid to be treated using the discharge gas; and
a power supply unit for supplying power to the electrode module,
wherein the electrode module comprises a first electrode structure and a second electrode structure which interact with each other and generate the plasma discharge, and the first electrode structure comprises a plate-shaped member with a plurality of through holes, and the second electrode structure has a mesh shape disposed above or below the first electrode structure.

13. The liquid treatment apparatus of claim 12, wherein the electrode module further comprises a plurality of dielectric members filled in a space formed between the first electrode structure and the second electrode structure.

14. The liquid treatment apparatus of claim 12, wherein the electrode module further comprises a plurality of floating electrodes filled in a space formed between the first electrode structure and the second electrode structure.

15. The liquid treatment apparatus of claim 12, further comprising an ultraviolet lamp for generating ultraviolet rays for treating the liquid to be treated in the main treatment space.

16. The liquid treatment apparatus of claim 1, further comprising:
an additional treatment tank for providing an additional treatment space in which a main treatment liquid discharged from the main treatment tank is stored; and
an additional treatment liquid supply pipe disposed in the additional treatment space and for supplying the main treatment liquid to the additional treatment space together with the bubbles.

17. The liquid treatment apparatus of claim 16, wherein the additional treatment liquid supply pipe comprises a curved extension part that is curved and extends to form a long flow path.

18. The liquid treatment apparatus of claim 16, wherein the additional treatment liquid supply pipe comprises a plurality of bubble discharge holes so that the bubbles flowing therein are discharged through the plurality of bubble discharge holes.

19. A nutrient solution cultivation system comprising:
a plant cultivation bed in which a plant to be cultivated by a nutrient solution is planted;
a nutrient solution tank in which the nutrient solution supplied to the plant cultivation bed is stored; and
a liquid treatment apparatus for treating a nutrient solution after use discharged from the plant cultivation bed,
wherein the liquid treatment apparatus comprises a main treatment tank in which a main treatment space for storing the nutrient solution after use is provided, a spray nozzle for spraying, in a bubble form, in the main treatment space, treatment gas for treating the nutrient solution after use, an ultraviolet lamp for generating ultraviolet rays for treating the nutrient solution after use in the main treatment space, and a plasma reactor using a plasma reactor so as to generate the treatment gas supplied through the spray nozzle, and a treatment liquid in which the nutrient solution after use is treated by the liquid treatment apparatus and is discharged, is supplied to the nutrient solution tank.

20-22. (canceled)
